(19) United States
(12) Patent Application Publication
(10) Pub. No.: US 2015/0348053 A1
(43) Pub. Date: Dec. 3, 2015

(54) Monitoring User Activities on Client Devices by Imaging Device Drivers

(71) Applicant: Lexmark International, Inc., Lexington, KY (US)

(72) Inventor: Gustavo Nieto, Denville, NJ (US)

(73) Assignee: Lexmark International, Inc., Lexington, KY (US)

(21) Appl. No.: 14/287,328

(22) Filed: May 27, 2014

(51) Int. Cl. G06Q 30/00

(52) U.S. Cl. CPC G06Q 30/018

(57) ABSTRACT

An imaging device driver on a client device detects user activity on at least one application executing on the client. If the detected user activity is determined to correspond to a predefined operation, the device driver sends the detected user activity to a server connected to the client. The server determines whether the activity exceeds a predefined limit. If it does, the server delivers a report to a connected monitoring device indicating that fact. Other embodiments note techniques for determining which of the one or more user activities detected by the imaging device driver are sent for monitoring and delivering a report to the monitoring device for notice of an investigator, to name a few.

### FIELD OF THE INVENTION

The present invention relates to monitoring user activities in applications executing on client devices using imaging device drivers installed on the client. It further relates to delivering reports to monitoring devices indicating users performing predefined operations and whether users exceed limits in performing such. The delivery and format of the reports define various embodiments.

### BACKGROUND

Fraud and data leaks are two issues constantly faced by organizations. In creating an honest and secure workplace environment, it is important for organizations to ensure that employees do not commit fraud or exchange restricted information with others not entitled to receive it. Monitoring activities within and/or from the organization is therefore crucial in identifying whether fraud is being perpetuated by any of its employees or if any private corporate or personnel data is being leaked.

Traditionally, employees would file reports indicating suspicious activities in the organization. Special investigation units would then look into each filed report and collect necessary evidence to confirm its accuracy. However, waiting for employees to file reports on suspicious activities is time-consuming. It is also difficult to confirm the accuracy of each filed report since no substantial evidence to back up the reported activity may be found.

To this end, a number of existing fraud detection software tools may be purchased from software vendors for installation on organization's computing systems (e.g. client devices of the employees, local network) for monitoring electronic activities of users or employees. However, functionalities of these tools may be preconfigured by the vendors and these tools may not allow organizations to add other functionalities or to modify settings therein.

What is needed is a system and method for monitoring activities of employees utilizing computing systems within an organization wherein special investigation units or investigators may easily set information to be monitored. A method for automatically alerting fraud investigators of employees or users suspected to be practicing fraud or sharing data to entities not entitled to receive the data is also needed. Additional benefits and alternatives are also sought when devising solutions.

### SUMMARY

The above-mentioned and other problems are solved by systems and methods of monitoring user activities on client devices using imaging device drivers. User activities are those activities performed by a user on an application executing on the client device, such as the clicking of a mouse button, entering alphanumeric characters, performing keyboard shortcuts, and the like. In a representative embodiment, the imaging device driver detects user activity and determines whether the detected user activity corresponds to an operation predefined by a fraud investigator to be indicative of or leading to fraud or data leak. If so, a notice indicating the user action is sent to a server for tracking a frequency of the user in performing such activity. Upon determining that a limit for performing the predefined operation has been exceeded by the user, the server sends a report to a monitoring device indicating that the user has exceeded a limit in performing a predefined operation. In this way, fraud investigators will be automatically alerted of users performing suspicious activities on the client devices. Software, executable code, interfaces, and computing system environments typify the embodiments. Other embodiments note techniques for delivering the reports to monitoring devices.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a computing system environment for monitoring user activities on a client device using an imaging device driver;

FIG. 2 is a diagrammatic view of an example method of delivering notices of detected user activities corresponding to predefined operations to a server;

FIGS. 3-4 show example embodiments of a report indicating users performing suspicious activities received by the fraud investigators and/or administrative users; and

FIG. 5 is a flowchart showing an example method of delivering reports of user activities detected by an imaging device driver to a monitoring device over a network.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, systems and methods for monitoring user activities on client devices using imaging device drivers are described herein.

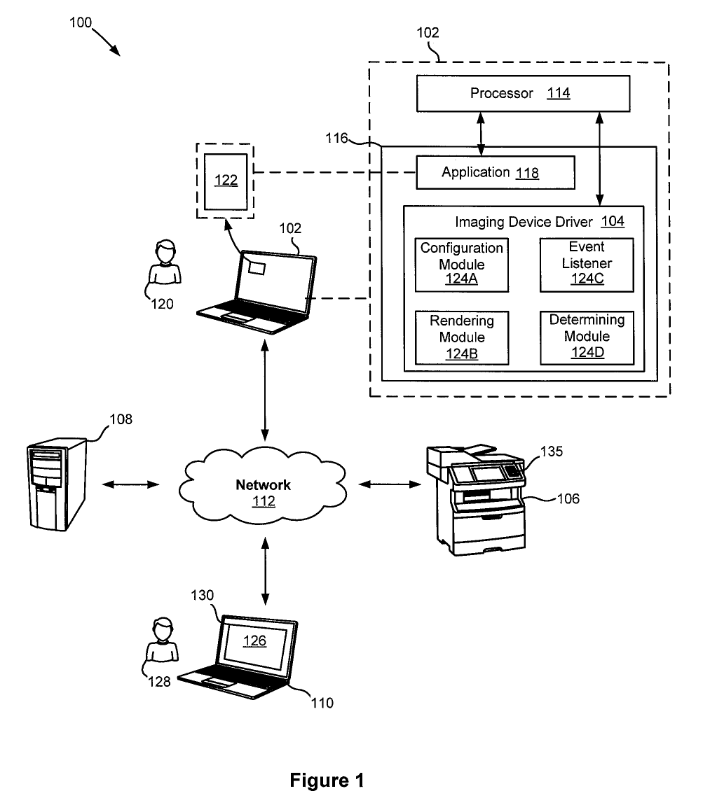

With reference to FIG. 1, system 100 for delivering automatic reports to fraud investigators indicating suspicious user activities includes client device 102 having imaging device driver 104 installed thereon for facilitating communications with imaging device 106, as is typical in a device driver. System 100 further includes server 108 and monitoring device 110 communicatively connected with client device 102 and imaging device 106 via network 112. Network 112 may be a local area network (LAN), a wide area network (WAN), and may also be a public or a private network. Any communication medium such as cable, optical fiber, radio carriers, etc., or combination thereof may serve as connection links in network 112.

In addition to facilitating communications with imaging device 106, imaging device driver 104 detects user activities on client device 102 and determines whether the detected activities correspond to operations that are determined to be a possible practice of fraud or of leaking private data within and/or from the organization. Imaging device driver 104 sends these detected activities as notices to server 108. Server 108 then determines whether the detected activities are suspicious enough to require fraud investigators as well as bodies in the organization to be alerted. If so, server 108 sends reports for accessing by investigator 128 on monitoring device 110. Investigator 128 may be a fraud investigator, a corporate head assigned to be informed of suspicious activities of user 120 in the organization, a direct supervisor of user 120, and the like.

Client device 102 is any computing device such as a personal computer, a laptop computer, a workstation computer, or a mobile computing device having processor 114 and data storage medium 116 for storing executable instructions such as imaging device driver 104 and application 118. Client device 102 is utilized by user 120 for executing application 118. Application 118 refers to one or more applications on client device 102 executed for accessing data 122, such as a text processing application, a form processing application, a spreadsheet, a database application, a media player, a web browser, and the like. In another aspect, application 118 may be an application for user 120 to perform operations on imaging device 106, such as faxing, e-mailing, copying, and/or scanning. Application 118 may also be delivered over network 112 from a remote storage location such as an application server or purchased from a software vendor, for example.

Data 122 refers to a document, content in a document such as a character string or region/s of interest in a document and/or a combination of such for monitoring by imaging device driver 104. Data 122 may be of any format such as an image, a text file, a web page, and the like which may be stored locally or retrieved from a remote location. Data 122 may further include target content or a predefined element set to be monitored for changes triggered by a user of application 118. Target content may be social security numbers, contact numbers, company names, project names, and other similar data strings, key phrases, or proprietary information considered to be vital in the organization.

Imaging device driver 104 includes one or more executable instructions for installation on client device 102. Imaging device driver 104 may be initially residing in a storage location such as a USB, a CD/DVD, and a hard drive, or may be downloaded from server 108. Once installed on client device 102, imaging device driver 104 determines whether application 118 is executing on client device 102. Since processor 114 of client device 102 is communicatively connected with application 118, imaging device driver 104 activates once application 118 is detected by processor 114 to be executing. It may be apparent to skilled artisans that imaging device driver 104 may be integrated within application 118 such that imaging device driver 104 is activated once application 118 is determined to be executing on client device 102. Thus, imaging device driver 104 behaves synchronously with application 118.

Imaging device driver 104 includes one or more modules 124 or executable instructions that may be activated after installation on client device 102 and/or upon determining that application 118 is executing. As is typical in imaging device drivers, imaging device driver 104 includes configuration module 124A and rendering module 124B. Configuration module 124A establishes communications between client device 102 and imaging device 106 which may be any device capable of printing and other functions such as faxing, e-mailing, copying, and/or scanning. Imaging device 106 may further be a part of a group of imaging devices or “fleet” for releasing data from server 108 to be printed thereon. Managed Print Services (MPS) is but one popular implementation including server 108 for releasing data or “print jobs” on imaging device 106.

Rendering module 124B converts one or more files based on the print settings desired by user 120 and/or rendering “print jobs” to imaging device 106. A user interface serving as an operating panel for configuration and/or rendering print jobs may be provided as application 118 on client device 102 or as user interface 135 on imaging device 106. Printing settings include options selected by user 120 on the user interface prior to performing an imaging operation on imaging device 106 and may include paper type, paper weight, paper texture, resolution, color profiles, among others. For example, user 120 may indicate that a document be printed in “A4” format. Rendering module 124B then converts the document in “A4” format as requested by user 120 and renders the converted document to imaging device 106 for printing thereon.

In the present disclosure, imaging device driver 104 further includes additional modules event listener module 124C and determining module 124D. Event listener module 124C detects one or more events triggered by user 120 while application 118 is executing on client device 102. Events may include keyboard events, mouse events, and the like. Imaging device driver 104 may be communicatively connected with other internal and/or external device drivers on client device 102, such as a keyboard driver, a mouse driver, and the like, to detect events triggered by user 120. Alternatively, imaging device driver 104 coordinates with processor 114 to determine whether an event has been triggered on client device 102 or not, since it is typical for processors on client device 102 to process instructions received by client device 102. For example, event listener module 124C may be able to detect user 120 entering characters on a keyboard, making a selection on a graphical user interface of client device 102, and the like. Other types of user input or events on client device 102 may be apparent to those skilled in the art.

Detected activities of user 120—or events triggered by user 120 that have been detected by event listener module 124C—are then passed on to determining module 124D. Determining module 124D determines whether any of the detected user activities correspond to a predefined operation. A predefined operation refers to specific user activities or operations set by investigator 128 to be monitored on client device 102, such as viewing, altering, printing, e-mailing, and the like. These also include operations that the fraud investigator should be aware of since these may be indicative of a practice of fraud or data leak in the organization. Determining module 124D may compare detected activities with a list of predefined operations to determine whether the detected activities correspond to any of the predefined operations.

Still, determining module 124D includes executable instructions for identifying whether the predefined operation is performed on or includes data 122. For example, upon determination of a predefined operation on client device 102, determining module 124D analyzes whether content associated with the predefined operation includes data 122 therein. The content associated with the predefined operation, such as a screen shot image or a keystroke log, may be converted into information for use in the delivery of the reports, for instance.

In one embodiment, upon determination that user 120 performed a screen print operation, the screen shot captured by user 120 may be converted into text and determined whether the text corresponds with any data 122. In another embodiment, upon determination that user 120 is viewing or accessing an e-mail application, executable instructions of determining module 124D determines whether any data 122 is included in a content of an e-mail message. Determining module 124D may access a memory associated with imaging device driver 104 (e.g. portion of memory on client device 102) or communicate with server 108 having the list of predefined operations as well as applications 118 and/or data 122 to be monitored to perform the comparison of events and/or analysis. In other embodiments, analyzing of content associated with the predefined operation may be performed on server 108.

Upon detecting activities of user 120 on client device 102 and determining that the activity corresponds to a predefined operation by event listener module 124C and determining module 124D, respectively, imaging device driver 104 sends a notice indicating user 120 performing the predefined operation to server 108. Executable instructions on server 108 then track how frequent user 120 performs the predefined operation by incrementing the times that it receives the notice, for example. Upon determining that a limit in performing the predefined operation has been exceeded by user 120, server 108 then generates and sends a report for accessing on browser 130 of monitoring device 110 for commencing the investigation. Google Chrome™ and Internet Explorer® are two popular examples of browser 130.

Server 108 is used to store information such as the predefined operations, user profiles, limits for each predefined operation, data 122, and the like. In other aspects, server 108 stores user activities detected by imaging device driver 104 on client device 102. The user activities may be stored in an archive on server 108, for instance. It may be apparent to skilled artisans that the user activities may be stored on server 108 for a particular period, depending on corporate policy.

Server 108 is communicatively coupled with monitoring application 126 on monitoring device 110 utilized by investigator 128 for retrieving the reports and/or determining real-time activities of user 120 on client device 102. Monitoring application 126 is accessed through browser 130 of monitoring device 110.

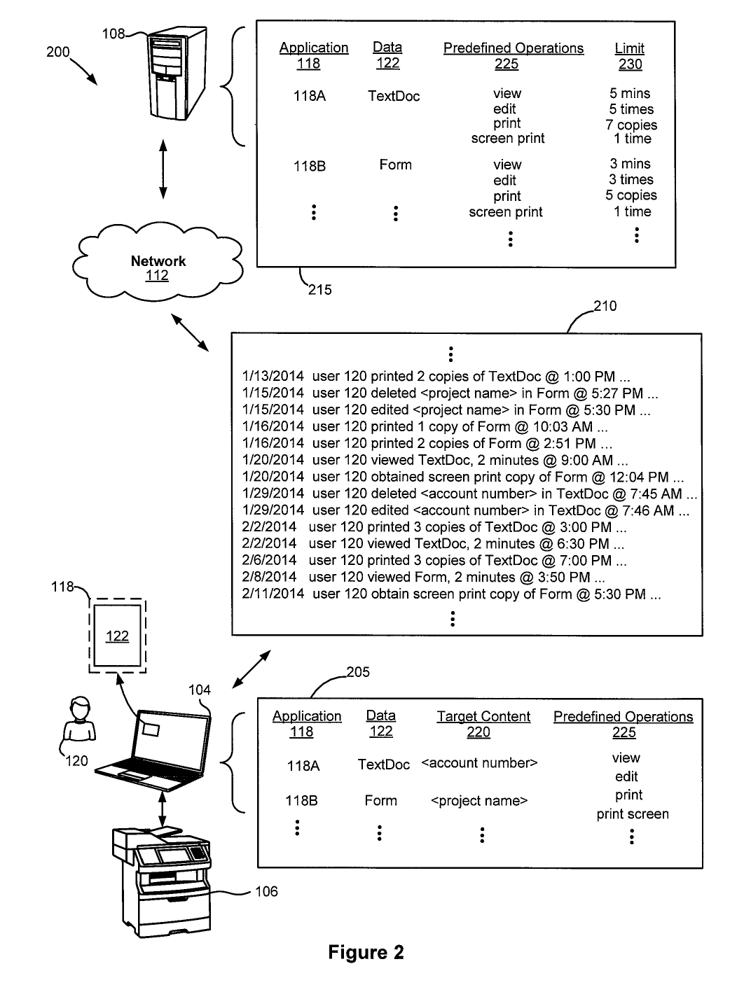

Aside from retrieving reports, monitoring application 126 may be used by investigator 128 to set and/or update configurations for imaging device driver 104. Monitoring application 126 may be accessed by investigator 128 to define operations for monitoring by imaging device driver 104 on client device 102, set user activities that correspond to those operations, establish limits for user 120 in performing the predefined operations, identify a location or a format of target content on data 122, and like configurations for reference by imaging device driver 104. Investigator 128 may provide through monitoring application 126 the specific location of target content on data 122 for identification of imaging device driver 104. The location may be a relative position of the target content within data 122, such as a set of coordinates, for example. In other aspects, investigator 128 may specify a format of the target content for identification of imaging device driver 104. For example, target content may be composed of 7 numeric characters. Investigator 128 may further indicate on monitoring application 126 particular application 118, client device 102, user 120, and/or a combination thereof to be monitored by imaging device driver 104, such that server 108 receives notices of detected activities associated with the particular application 118, client device 102, user 120, and/or their combination. In this way, the functionality of imaging device driver 104 is not limited to establishing connections with imaging device 106 and other functionalities typical in a device driver, but also capturing user activities corresponding to operations indicative of or eventually leading to fraud or data leak. FIG. 2 is a diagrammatic view of example system 200 showing the delivery of notices to server 108 indicating user 120 performing predefined operations on client device 102 of FIG. 1. Table 205 includes the configurations set by investigator 128 in detecting activities by user 120, while table 210 includes notices indicating user 120 performing activities corresponding to predefined operations on predetermined data. Table 215 includes the limits for user 120 to perform the predefined operation. Table 205 may be accessed on the memory associated with imaging device driver 104 while table 215 may be accessed on server 108.

Table 205 shows predefined operations 225 for monitoring on client device 102 and include applications 118A, 118B for accessing data 122 such as TextDoc and Form, respectively. TextDoc and Form data 122 may each include target content 220 therein. Another table including the location or the format of target content 220 on data 122 may be accessed for reference by imaging device driver 104. As shown on Table 205, example predefined operations 225 may include view, edit, and/or print operations.

An edit operation includes changing one or more properties of data 122, such as addition or deletion of elements thereof (e.g. alterations of a company name in the company web page). Imaging device driver 104 will be able to detect whether the changes performed by user 120 on data 122 have been applied thereon. A print operation includes producing a hard copy of data 122, but may cover performing a screen print operation and capturing a screen shot associated with the screen print operation having data 122. Other operations for monitoring by imaging device driver 104 may be set by investigator 128 through monitoring application 126.

Table 205 also shows TextDoc and Form data 122 having target content 220 including <account number> and <project name>, respectively, to be monitored for any activities or events such as changes performed by user 120. Example table 205 may be stored in the memory associated with imaging device driver 104 or on server 108. Imaging device driver 104 may refer to table 205 to compare detected events on client device 102 with predefined operations 225 and to identify whether the detected event on application 118 is performed on predefined data 122 and/or target content 220. Investigator 128 may add, delete, or modify information included on table 205 by accessing monitoring application 126.

Upon determining by imaging device driver 104 that applications 118A, 118B are executing on client device 102, imaging device driver 104 starts to detect for any activity of user 120 thereon. A recording session, which may include a log of user activities detected by imaging device driver 104 while application 118 is executing on client device 102, may commence upon such determination. The recording session may be created in the memory associated with imaging device driver 104 or on server 108. Event listener module 124C (FIG. 1) of imaging device driver 104 listens for any events on client device 102 such as a click of a mouse, strokes on a keyboard, selections on the interface, and/or other types of user inputs that are triggered by user 120. In other aspects, event listener module 124C may include a keylogger. Upon identification by event listener module 124C of an event or an activity on client device 102, determining module 124D then determines whether the detected user activity corresponds to any predefined operations 225. Imaging device driver 104 also determines whether the detected user activity is performed on predefined application 118, data 122, and/or target content 220 by accessing table 205.

If both of the determinations have been satisfied, imaging device driver 104 then sends a notice to server 108 indicating user 120 performing such activity. The notice indicating such activity may be automatically sent at/near real-time to server 108 so that server 108 may be notified of the suspicious activity performed on client device 102 and start to determine how frequent user 120 is performing the activity. The notice may include data associated with the activity of user 120, such as the screen shot associated with the screen print operation, a keystroke log, and the like.

The notice may be delivered to server 108 in a data package. For example, imaging device driver 104 may send a notice including: a user identifier (“user 120”), an identifier of application 118 (“App 118A” or “App 118B”), data identifier (“TextDoc” or “Form”), an identifier of the client device used in accessing data 122 (“client device 102”), and a date and time stamp of the activity (“1/13/2014”, “1:00 PM”) to server 108. Imaging device driver 104 may deliver the notice to server 108 in a format such as “user 120 printed 2 copies of TextDoc @ 1:00 PM as of 1/13/2014” or the like. Other information associated with user 120 such as company profile or account details may also be sent to server 108 for reference of investigator 128. For illustrative purposes, table 210 shows notices indicating user activities corresponding to predefined operations 225 for the duration of January to February 2014. Imaging device driver 104 sends notices to server 108 such as: (1) user 120 has printed 2 copies of TextDoc at 1:00 PM of January 13, (2) user 120 has printed 3 copies of TextDoc at 3:00 PM of Feb. 2, 2014, and (3) user 120 has printed 3 copies of TextDoc at 7:00 PM of Feb. 6, 2014. Server 108 may access table 215 for determining limit 230 for user 120 to print a copy of TextDoc data 122, which in this example is 7 copies.

Server 108 may flag user 120 such that when server 108 receives another notice indicating user 120 printing a copy of TextDoc, server 108 increments the number of times user 120 has performed the printing operation under predefined operation 225. An edit and/or screen print operation may be limited by a user to be performed once, depending on the configuration set by investigator 128. In one aspect, user 120 may be limited to viewing or accessing data 122 for a maximum of 5 minutes, which may be 5 minutes after launching application 118 or accessing data 122, or as set by investigator 128. Other embodiments of determining how frequent user 120 performs the particular predefined operation 225 are apparent to those skilled in the art. They may be likely set or defined by investigator 128 according to corporate policy.

With reference to notices on table 210 and with reference to limit 230 on table 215, user 120 has (1) printed TextDoc 8 times starting 1/13/2014; (2) edited <project name> in Form on Jan. 15, 2014 @ 5:30 PM; (3) edited <account number> in TextDoc on Jan. 29, 2014 @ 7:45 AM; and (4) obtained screen shot of Form on Jan. 20, 2014 @ 12:04 PM and 2/11/2014 @ 5:30 PM for the duration of January to February 2014. Since user 120 has exceeded limits 230 (as indicated on table 215) for performing such predefined operations, server 108 generates and delivers reports to monitoring device 110 indicating that user 120 exceeded limits 230 for performing such predefined operations. This way, investigator 128 is alerted of suspicious activities performed by user 120 on client device 102. It may be apparent to those skilled in the art that reports may be delivered on a particular duration, such as weekly, monthly, and the like.

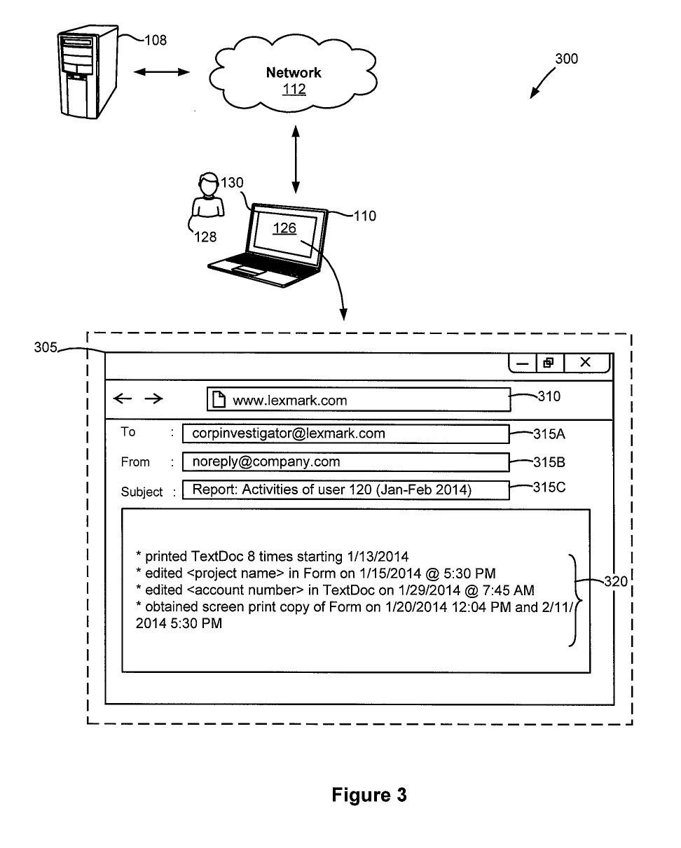

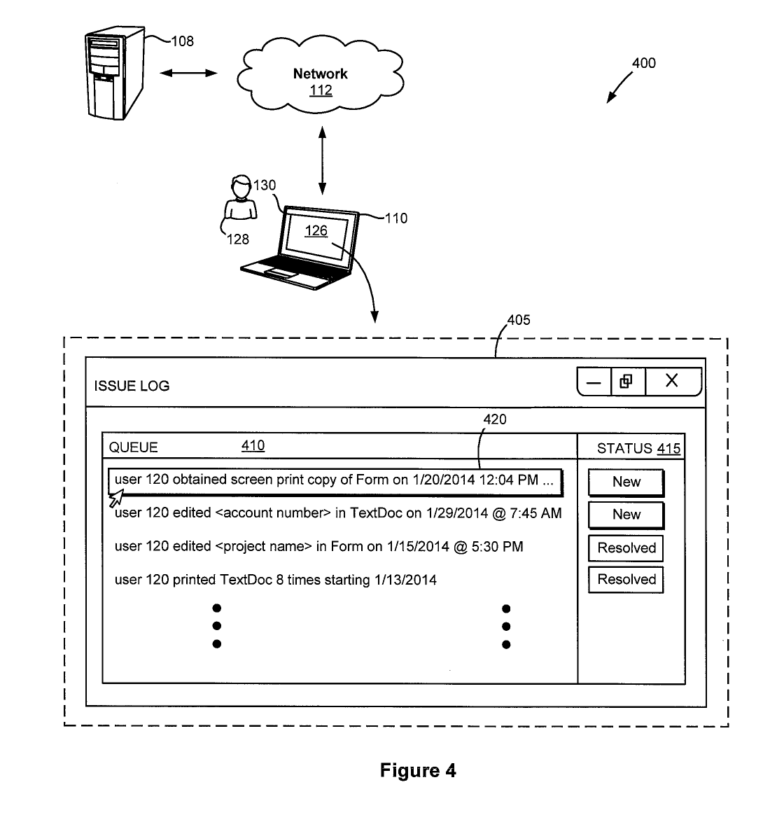

FIGS. 3 and 4 show example embodiments of reports 300 and 400, respectively, delivered from server 108 to monitoring device 110 utilized by investigator 128. FIG. 3 shows browser 130 receiving a report through e-mail client 305, while FIG. 4 shows issue log 405 including queue 410. E-mail client 305 and issue log 405 includes reports from server 108 indicating user 120 performing predefined operations and exceeding limits 230. Example reports shown in FIGS. 3 and 4 are with reference to the notices shown in table 210 of FIG. 2 that exceed limits 230.

In one example embodiment for receiving a report shown in FIG. 3, browser 130 may include e-mail client 305 for displaying an e-mail message indicating reports from server 108 which may be an e-mail server. E-mail client 405 may be a stand-alone client or a web service. In one aspect, e-mail client 305 may be accessed through an e-mail client location entered on a path block 310 or invoked from an icon on a user interface of monitoring device 110. As is typical in an e-mail, e-mail client 305 may provide message headers 315 and message block 320 indicating the report. Message headers 315 may include, but are not limited to, sender 315A, a recipient 315B, and a subject 315C. Recipient 315B may include investigator 128. E-mail client 305 may include the reports in an attached document, for example. Information associated with user 120 or with the activity performed that corresponds to predefined operation 225 may be included with the report. Other embodiments in delivering a report through an e-mail, accessing the e-mail client, and displaying the report in an e-mail are apparent to those skilled in the art.

Alternatively, server 108 may deliver the report to a workflow. The workflow may be a series of steps and/or operations for investigating suspicious activities of user 120, as indicated in the report, and may depend on the corporate policy. For example, the workflow may include users having a specific function in a step and/or operation, such as investigator 128 assigned to look into reports on operations being performed by user 120 or another investigator 128 assigned to investigate user activities on particular data 122.

Issue log 405 may be part of a ticketing workflow and have each report as a ticket. As is shown, server 108 may deliver the reports as separate tickets to queue 410 of issue log 405. Issue log 405 also includes status tab 415 for providing the status of a report in the workflow, such as “New” and “Resolved”. Other embodiments of process workflows for investigating user activities on client devices are apparent to skilled artisans.

For instance, example report 420 may provide a link to a form, a page, or a step in the workflow. In this example, report 420 is a link and other information associated with report 420 may be shown upon selection of report 420. Report 420 may allow investigator 128 to assign the reported activity to another investigator in the workflow or to forward the reported activity to the next step in the process. Report 420 may have an attachment, such as a text file or an image file, which may include information associated with the reported user activity. The attachment may be displayed, downloaded, and/or printed from browser 130. The attachment may be a text file having detailed information associated with the reported user activity. The attachment may also be the screen shot obtained by user 120 in performing activity screen print operation on data 122 or log of keystrokes performed by user 120 while application 118 is executing.

It may be apparent to skilled artisans that investigator 128 may be informed of the suspicious activity on client device 102 via alert processes which may depend on the configurations of system 100 in FIG. 1. For example, a notification indicating a new work item on issue log 405 may be sent as a text message (e.g. Short Message Service messages) to a mobile device of investigator 128, a short notification e-mail indicating the new work item, an audio notification (e.g. a VoiceXML document) on browser 130, or a combination thereof. The notification may include a sentence for prompting investigator 128 to check e-mail client 305 or issue log 405 for full details of reports, thereby commencing the investigation.

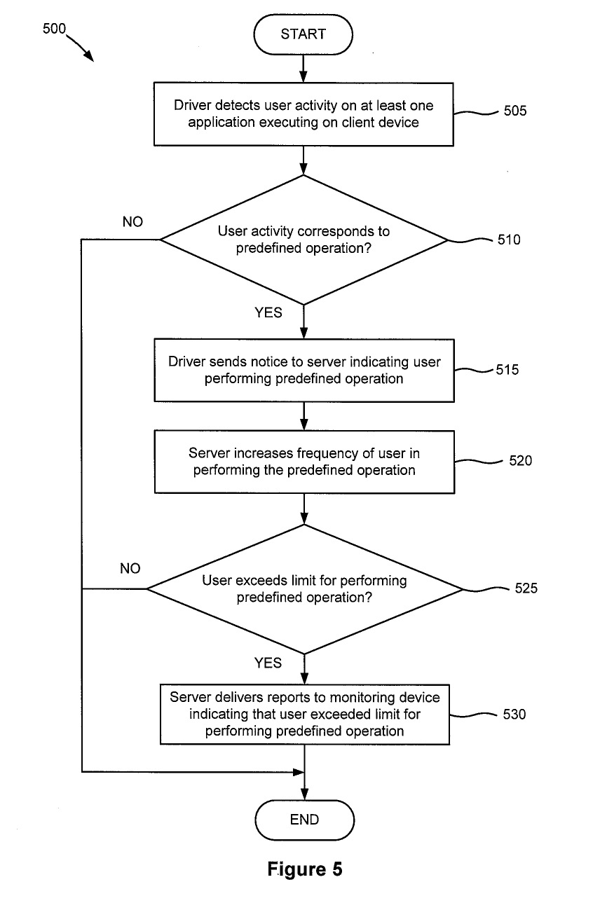

With reference to FIG. 5, flowchart 500 presents one example method of delivering reports indicating user (120) performing suspicious electronic activity on client device (102). At 505, imaging device driver (104) detects an activity of user (120) on at least one application (118) executing on client device (102). Event listener module (124C) of imaging device driver (104) detects events or activities of user (120) on client device (102). At 510, imaging device driver (104) then determines whether the detected user activity corresponds to any of the predefined operations (225). Imaging device driver (104) further detects whether the user activity is performed on predefined data (122). For example, in FIG. 2, imaging device driver (104) detects user (120) entering alphanumeric characters on the keyboard device connected to client device (102) while accessing TextDoc data (122), specifically on <account number> element therein which is target content (220). Imaging device driver (104) may refer to the memory associated with it or to server (108) having table (205), for example, to determine whether the detected activity corresponds to predefined operation (225). Upon a positive determination at 510, imaging device driver (104) sends notices to server (108) indicating user (120) performing predefined operation (225) on client device (102) at 515. Otherwise, imaging device driver (104) waits for another activity of user (120) on client device (102).

At 520, server (108) increases the number of times user (120) has performed the predefined operation (225) upon receiving the notice. Executable instructions on server (108) may increase a frequency or numeric count of user (120) in performing the predefined operation (225). At 525, server (108) then determines whether user (120) exceeded limit (230) in performing predefined operation (225) based on the latest frequency count. Server (108) may refer to table (215) and compare the latest frequency count with limit (230) to determine whether user (120) exceeded the limit in performing the activity.

Upon a positive determination thereof, server (108) delivers a report to monitoring device (110) indicating that user (120) exceeded limit (230) for performing the predefined operation (225) at 530. Investigator (128) can then take appropriate actions in dealing with the reported suspicious activities of the user (120) upon receipt of the report. The report may be delivered in different embodiments, as shown on FIGS. 3 and 4, and alert processes may be executed to inform investigator (128) of the suspicious activity or new work item in the investigation work flow, such as in a text message received on a mobile device of investigator (128), an audio output on browser (130) of monitoring device (110), and/or a combination of such, depending on the business policy. Otherwise, upon determining that user (120) did not exceed limit (230) in performing the activity corresponding to predefined operation (225), imaging device driver (104) waits for another activity from user (120).

Relative advantages of the many embodiments should now be apparent to skilled artisans. They include but are not limited to: (1) adding activity detection to the functionalities of imaging device drivers; (2) providing a method of updating the monitoring tool which in this case is the imaging device driver; (3) providing a method of determining which of the detected user activities are suspicious enough and require fraud investigators and/or administrative users to be alerted; and (4) generating and delivering automatic reports to fraud investigators and/or administrative users including other information associated with the suspicious activity that have been documented.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. A method of monitoring user activities in at least one application executing on a client device having installed thereon an imaging device driver, comprising:
by the imaging device driver, detecting a user activity on the at least one application executing on the client device;
upon a positive detection, determining whether the detected user activity corresponds to a predefined operation that the imaging device driver is configured to monitor; and
upon a positive determination, delivering a report to a monitoring device from a server connected to the client device and the monitoring device, the report indicative of a user performing the detected user activity corresponding to the predefined operation.

2. The method of claim 1, further including determining whether the user exceeded a limit for performing the detected user activity and upon a positive determination, delivering the report to the monitoring device from the server, the report indicative of the user exceeding the limit for performing the detected user activity.

3. The method of claim 1, further including delivering to the monitoring device data associated with the detected user activity, the data including at least one of a user identifier, an identifier of the at least one application executing, a data identifier, a client device identifier, and a time stamp of the detected user activity.

4. A system for monitoring user activities on at least one application executing on a client device using an imaging device driver installed on the client device, comprising:
an imaging device driver for installation on the client device, the imaging device driver operative to
detect a user activity on the at least one application executing on the client device, and
upon a positive detection, determine whether the detected user activity corresponds to a predefined operation that the imaging device driver is configured to monitor; and
a server in electronic communication with the imaging device driver and a monitoring device, the server operative to
receive from the imaging device driver the user activity determined to correspond to the predefined operation,
determine whether a user exceeded a limit for performing the user activity determined to correspond to the predefined operation, and
upon a positive determination, deliver a report to the monitoring device, the report indicative of the user exceeding the limit for performing the detected user activity corresponding to the predefined operation.

5. The system of claim 4, wherein the imaging device driver is further operative to receive one or more predefined operations to be monitored on the at least one application.

6. The system of claim 4, wherein the server has access to one or more predefined operations and a corresponding limit for each of the one or more predefined operations for performing user activities corresponding to the predefined operation.

7. The system of claim 4, wherein the server records one or more user activities detected while the at least one application is executing on the client device.

8. The system of claim 4, wherein the predefined operation corresponds to viewing content on the at least one application.

9. The system of claim 4, wherein the predefined operation corresponds to altering content on the at least one application.

10. The system of claim 4, wherein the predefined operation corresponds to printing content using the at least one application.

11. An imaging device driver for installation on a client device having at least one application for execution thereon, the imaging device driver including one or more executable instructions available in memory as stored on a server or as coded onto a tangible computer-readable medium, the one or more executable instructions for:
detecting a user activity on the at least one application when executing on the client device;
upon a positive detection, determining whether the detected user activity corresponds to a predefined operation that the imaging device driver is configured to monitor; and
upon a positive determination, delivering a notice to a server connected to the client device, the notice indicative of a user performing the detected user activity corresponding to the predefined operation.

12. The imaging device driver of claim 11, further including an instruction for receiving one or more predefined operations to be monitored on the at least one application executing on the client device.

13. The imaging device driver of claim 11, wherein the predefined operation corresponds to viewing content on the at least one application executing on the client device.

14. The imaging device driver of claim 11, wherein the predefined operation corresponds to altering content on the at least one application executing on the client device.

15. The imaging device driver of claim 14, further including an instruction for determining whether a save operation was performed on the at least one application if the predefined operation corresponds to the altering the content, and upon a positive determination, delivering the notice to the server indicating the user altering the content.

16. The imaging device driver of claim 11, wherein the predefined operation corresponds to printing content using the at least one application executing on the client device.

17. The imaging device driver of claim 11, wherein the instruction for detecting user activity further includes identifying whether the user is capturing a screen shot.

18. The imaging device driver of claim 17, further including an instruction for sending the screen shot to the server if the user is identified to capture the screen shot.

19. The imaging device driver of claim 11, wherein the instruction for detecting the user activity further includes detecting one or more keystrokes performed by the user.

20. The imaging device driver of claim 19, further including an instruction for sending the one or more keystrokes to the server.
